(19) United States
(12) Patent Application Publication
(10) Pub. No.: US 2005/0144024 A1
(43) Pub. Date: Jun. 30, 2005

(54) Subscriber network system and method for viewing images and exchanging messages

(76) Inventors: Walter G. Wojton, Pittsburgh, PA (US); William P. Wojton, McKeesport, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 10/746,828

(22) Filed: Dec. 24, 2003

(51) Int. Cl. G06F 17/60

(52) U.S. Cl. 705/1

(57) ABSTRACT

A system for effecting introductions includes a first and second subscriber; a service provider server configured to transmit at least one of a first and second image, wherein the first image is representative of the first subscriber and the second image is representative of the second subscriber; a first establishment having a first server configured to receive the second image from the service provider server and a first video monitor configured to display the second image; and a second establishment includes a second server configured to receive the first image from the service provider server and a second video monitor configured to display the first image. The first image is displayed as a function of the first subscriber registering with the system and the second image is displayed as a function of the second subscriber registering with the system. A method for effecting introductions using the system is also disclosed.

### BACKGROUND OF THE INVENTION

1. Field of the Invention

The present invention relates to systems and methods for viewing images and exchanging messages and, more specifically, to subscriber networks which incorporate such systems and methods.

2. Description of Related Art

There are numerous methods and systems in the prior art for effecting social introductions between individuals. These may include traditional methods, such as frequenting singles establishments for attempting in-person contact with another individual or posting an advertisement in a printed publication. Methods relying on technology include phone and Internet dating services. Each of the aforementioned methods includes both positive and negative aspects. For example, although in-person contact is the most personable form of acquainting oneself with another individual, it may be considered awkward and pose safety concerns for some individuals. Alternatively, although the initial contact through Internet dating may be safe and anonymous, it is performed in an asocial environment and through impersonal manners, such as e-mail. Prior art attempting to overcome these deficiencies includes U.S. Pat. No. 5,598,351 to Chater et al., which discloses a communication system for facilitating introductions by utilizing a plurality of terminals. The communication system in Chater et al. is deficient in that the use of a terminal constrains a user to the immediate area in which the terminal is located. Moreover, the communication system allows only one individual to utilize the terminal at a time, thus making it impractical for use in a large social establishment where more than one user would like to participate in the use of the communication system. Furthermore, the method of displaying user images is not dependent on the presence of users in other geographic areas and locales where the communication system is implemented. Therefore, the images displayed may become stale and outdated, which thereby reduces the relevancy and entertainment value of the communication system. Additionally, the prior art lacks the requisite secondary features, such as advertisement content and entertainment content, necessary to produce revenue and maintain the interest of users.

### SUMMARY OF THE INVENTION

To overcome the deficiencies of the prior art, what is needed, and has not heretofore been developed, is a system and method for introducing individuals to each other, while providing a degree of anonymity and safety, maintaining a level of interest and enjoyment in the system through various entertainment content and incentives, while also providing promotional advertisement and commercial content. Such a system must operate in a social environment as that is the most conducive environment in effecting social introductions between individuals. Additionally, such a system must be able to adapt to emerging technological trends so that it may continually maintain its appeal with users of the system.

Accordingly, a system for introducing individuals to each other is provided including a first and second subscriber subscribed to the network system and a service provider server configured to transmit content, wherein the content is at least one of a first image and a second image, wherein the first image is representative of the first subscriber and the second image is representative of the second subscriber. The network system also includes a first establishment, wherein the first establishment includes a) a first establishment server configured to receive the second image from the service provider server and b) a first video monitor configured to display the second image. Similarly, the network system also includes a second establishment, wherein the second establishment includes a) a second establishment server configured to receive the first image from the service provider server and b) a second video monitor configured to display the first image. A computer network communicatively connects the service provider server, the first establishment, and the second establishment. The first image is displayed on the second video monitor as a function of the first subscriber registering with the network system and the second image is displayed on the first video monitor as a function of the second subscriber registering with the network system.

The present invention provides a unique system and method for an individual to be introduced to other individuals who are also interested in meeting people. This has the effect of saving time and resources by creating a more efficient market than is typically encountered in current establishments oriented to socially introducing individuals to each other. Since this is a system by which the introduction process takes place in real time, individuals are contacting and being contacted during a period of time of their choosing, i.e., during a period of time when and where they wish to engage in the meeting process. Additionally, the system includes an inherent level of anonymity, yet allowing an individual to control the level of anonymity in relation to themselves. Due to the networked environment in which the system operates, subscribers to the system receive the advantage of viewing many more people than may be present in their immediate physical surroundings. Likewise, the individual by means of the invention may expand his or her presence to places beyond their immediate physical location. Furthermore, the requirement that a subscriber is only viewable to other subscribers when the subscriber is present in an establishment oriented to meeting other individuals results in the creation of a genuine collection of individuals who want to approach and be approached by other individuals.

The present invention also allows target marketing based upon particular demographics of the subscriber and non-subscriber individuals frequenting establishments participating in the system. The system allows for a variety of contents to be broadcast to individuals in the establishment, without the content being subject to governmental (i.e., FCC) imposed broadcasting restrictions. Thus, the content may include visual advertisements directed to tobacco, liquor, etc. In essence, the system provides a unique broadcasting medium encompassing a variety of content to be delivered to an audience in a social environment.

These and other advantages of the present invention will be understood from the description of the preferred embodiments, taken with the accompanying drawings, wherein like reference numerals represent like elements throughout.

### BRIEF DESCRIPTION OF THE DRAWINGS

FIG. 1 is schematic drawing of the entities and communications links involved in a subscriber network system; and

FIG. 2 is a front view of a video monitor displaying information relating to the subscriber network system.

### DESCRIPTION OF THE PREFERRED EMBODIMENTS

The present invention will now be described with reference to the accompanying figures. It is to be understood that the specific system illustrated in the attached figures and described in the following specification is simply an exemplary embodiment of the present invention.

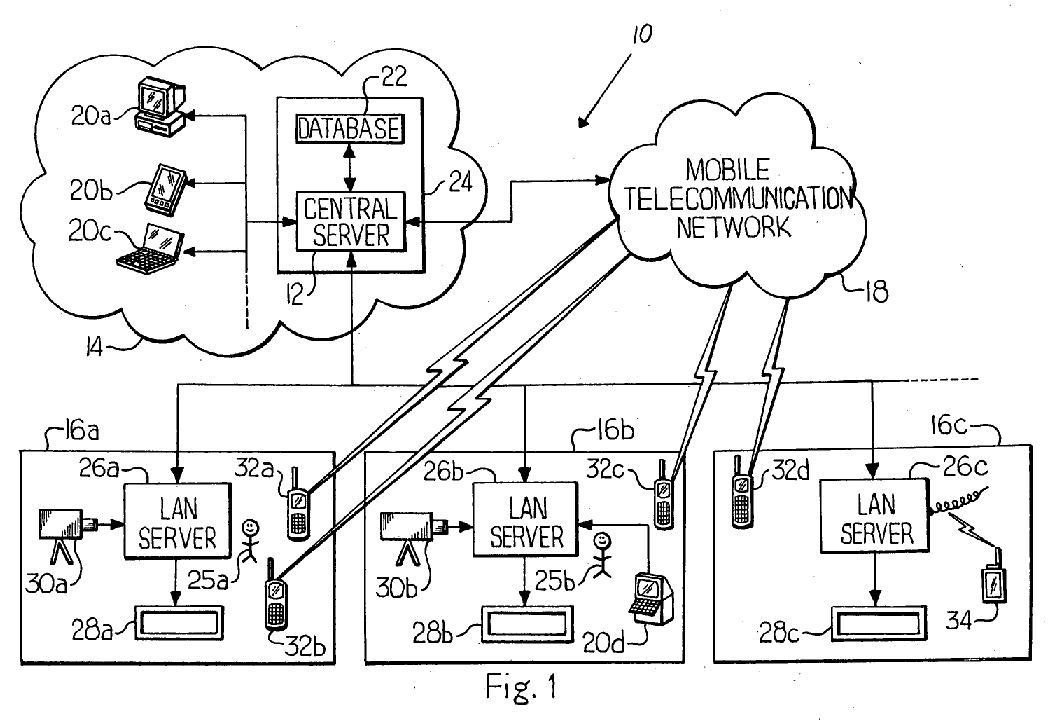

With reference to FIG. 1, the entities and the communicative connectivity between the entities within a network system 10 for introducing individuals to each other will now be described. In a desirable embodiment, the network system 10 includes a central server 12. Utilizing a computer network 14, such as the Internet, the central server 12 is communicatively connected to one or more establishments, for example, a first, second, and third establishment, 16a-16c, respectively, a mobile telecommunications network 18, and a plurality of personal computing devices 20a-20c. It is to be understood that communications between the above communicative entities may be implemented in a variety of ways including, but not limited to, land-line, wireless, and satellite-based systems. Thus, the communication links described hereinafter are merely exemplary and are not to be construed as limiting the invention in any manner.

The central server 12 may be any suitable computer system that is configured to transmit and receive data to and from one or more of the establishments 16a-16c, the mobile telecommunications network 18, and the plurality of personal computing devices 20a-20c. The central server 12 is communicatively connected to a database 22 which is configured to store a plurality of user profiles. The central server 12 is operated by a service provider 24, but it is to be understood that the central server 12 need not be within the physical premises of the service provider 24, as the server may be co-located at a location more suitable for the requisite bandwidth and database demands. Additionally, the server 12 may be construed to embody more than one physical machine to allow for distributed computing.

The plurality of personal computing devices 20a-20c may be utilized by individuals to subscribe to the network system 10. The personal computing devices 20a-20c may include, but are not limited to, a desktop computer 20a, a personal digital assistant 20b, and a notebook computer 20c. Each potential subscriber would subscribe with the service provider 24, preferably through a web site operated by the service provider 24. The subscription process involves a first subscriber 25a providing billing information and personal contact information. The billing information would be used to charge or debit the first subscriber 25a, preferably monthly, for a service fee associated with utilizing that network system 10. It is to be understood that billing may be administered by an entity other than the service provider 24. For example, the subscriber's service fee may be invoiced on the subscriber's phone bill by a communications service provider acting as an agent for the service provider 24. The personal contact information would also include a profile that is representative of the subscriber's characteristics as well as those characteristics that the first subscriber 25a prefers a potential romantic interest to possess. For example, in addition to providing their full name and preferred contact method, such as a phone number or an e-mail address, the first subscriber 25a would also provide information pertaining to their age, height, weight, current marital status, sexual orientation, etc. Additionally, the first subscriber 25a would provide an image of themselves that would be associated with his or her profile, although it is to be understood the image is meant to also encompass a video freeze frame or another still extracted from a video. Additionally, a video or animation may substitute and/or supplant the image. The central server 12 then stores each profile in the database 22. The central server 12 may also assign every subscriber a unique subscription number. The subscription number may be utilized to not only access the subscriber's account with the service provider 24 for profile update purposes and the like, but to also access system services from remote locations, as will be discussed hereinafter.

The establishments 16a-16c may be of various types of social gathering environments including, but not limited to, bars, clubs, restaurants, coffeehouses, and gaming facilities. Desirably, each establishment 16a-16c would enter into an agreement with the service provider for the establishments 16a-16c to serve as an affiliate in the network system 10. As an affiliate, each establishment 16a-16c would provide demographical information to the service provider 24. Demographical information may include the type of clientele who frequent the establishment 16a-16c. For example, an upscale club may include the 25 to 45 year old professional crowd having an upper middle class income level, whereas an ordinary bar may include blue collar workers within any age range. There may also be establishments that cater to individuals with alternative lifestyles. These types of demographics are presented by the respective establishments 16a-16c to the service provider 24. The service provider 24 then qualifies and/or quantifies this demographical information as data to be stored in the database 22.

Each establishment 16a-16c is provided with a Local Area Network (LAN) server 26a-26c, respectively, configured to transmit and receive data to and from the central server 12. Each establishment 16a-16c also includes a video monitor 28a-28c, preferably a plasma or LCD screen monitor, so as to utilize very little space, be practical to mount, and provide a wide viewing area. Optionally, a video camera 30a, 30b may also be installed within the establishment 16a-16c. The video monitor 28a-28c receives video signals from the respective server 26a-26c, whereas the video camera 30a, 30b transmits video signals to the server 26a-26b, respectively. Thus, the LAN, or intranet, of any establishment can be considered to include the server 26, the video monitor 28, and optionally, the video camera 30, all of which are communicatively connected to the central server 12. It is to be understood that more than one video monitor 28 and camera 30 may be utilized per each establishment 16a-16c. Furthermore, the establishment 16a-16c may also offer a personal computing device, such as a kiosk 20d, which allows the clientele of an establishment to subscribe to the network system 10 while patronizing the establishment. If any of the cellular phones 32a-32d are camera phones, then such cellular phones 32a-32d may also be used to subscribe to the network system 10. The subscription process would be similar to that carried out via the personal computing devices 20a-20c outside the establishment (e.g., a home computer).

The mobile telecommunications network 18, such as a GSM cellular network, is configured to route both voice and data communications to and from the central server 12 to a plurality of personal communication devices, such as cellular phones 32a-32d or other suitable devices. Preferably, in addition to voice capabilities including voice-mail, the cellular phones 32a-32d are capable of receiving and transmitting data in the form of text messages, i.e., SMS text messaging.

With continuing reference to FIG. 1, the operation of network system 10 will now be described. After having established a subscription with the service provider 24, the first subscriber 25a may utilize the benefits associated with the network system 10. Specifically, the first subscriber 25a may visit any establishment 16a-16c affiliated with the network system 10. Upon entering any such establishment, for example, the first establishment 16a, the first subscriber 25a is required to register with the network system 10. Registering entails notifying the central server 12 that one has entered the first establishment 16a. Registering may be done either automatically, manually, or a combination thereof.

In one embodiment of the present invention involving manual registration, the first subscriber 25a may be issued a member card bearing a unique identifier that corresponds to the individual's profile. The member card may be of any suitable type, including a bar-coded card that may be read by a bar-code scanner. Thus, the first subscriber 25a would scan their member card upon entry into the first establishment 16a. Preferably, the bar-coded identifier would then be transmitted via the server 26a to the central server 12. The central server would then be alerted to the presence of the first subscriber 25a in the first establishment 16a. In another embodiment of the present invention, also involving manual registration, the first subscriber 25a may use his or her cellular phone 32a to dial an access number provided by the service provider 24. After being prompted, preferably by an automated system, the first subscriber 25a would enter their subscription number and an establishment identifier, uniquely identifying the first establishment 16a. The establishment identifier may be posted in a visible area within the first establishment 16a. Any communications via the cellular phone 32 would be routed through the mobile telecommunications network 18 to the central server 12. Additional techniques that may be employed to allow the first subscriber 25a to manually register on the network system 10 may include, but are not limited to, submitting to biometric recognition hardware such as fingerprint scanners (which may be integrated into the cellular phone), voice scanners, or retinal scanners.

In one embodiment of the present invention involving automatic registration, the first subscriber 25a may carry a wireless device 34 capable of wi-fi communications within “hot-zones”, such as a SmartPhone. It is known to those of ordinary skill in the art that “hot-zones” are localized areas providing wireless networking services within a predetermined distance from a transceiver. The compatible wireless device 34 may be recognized and operate within the “hot-zone” by utilizing an auto-sensing and/or auto-authentication protocol (i.e., 802.11b, Bluetooth, etc.) inherent in such wireless technology. Thus, the first subscriber 25a may be automatically registered with the network system 10 when the wireless device 34 that he or she is carrying enters a “hot-zone” in the first establishment 16a.

When the first subscriber 25a leaves the establishment, the first subscriber 25a needs to be either manually or automatically unregistered from the network system 10. With manual unregistration, the first subscriber 25a would either subject him or herself to any of the above-mentioned scanners, or alternatively, may use their cellular phone 32a by dialing the number designated by the service provider 24 in order to notify the network system 10 that he or she has left the first establishment 16a. With automatic unregistration, the system would be alerted that the first subscriber 25a has left the first establishment the moment the wireless device 34 carried by the first subscriber 25a is outside the “hot-zone” of the first establishment 16a.

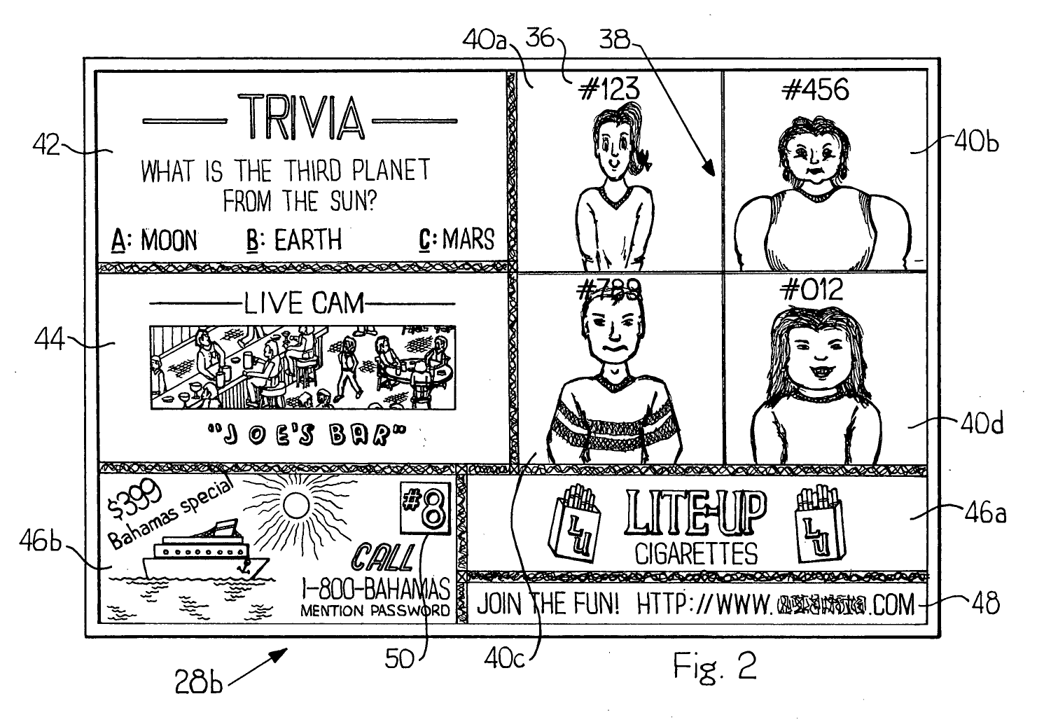

With reference to FIG. 2 and with continuing reference to FIG. 1, upon registering with the network system 10, the first subscriber 25a is assigned a unique identification number 36, such as “123”. Use of the identification number allows the first subscriber 25a to maintain a level of anonymity while providing a way for others to contact the first subscriber 25a. It is to be understood that the identification number 36 is different than the subscription number previously obtained by the first subscriber 25a during the subscription process. The identification number 36 is unique in that it is valid only while the first subscriber 25a is present in the first establishment 16a. Thus, when unregistering from the system by leaving the first establishment 16a, and then registering on the system by entering a different establishment, such as the second establishment 16b, the first subscriber 25a will be assigned a different identification number 36 than what was assigned to the first subscriber 25a when they were present within the first establishment 16a, even if the change in establishments occurs within the same evening, for example.

With reference to FIG. 2 and with continuing reference to FIG. 1, the display area of the video monitor 26a may be partitioned into frames of various dimensions such that each frame may have different content associated with it and which is displayed therein. Primarily, the video monitor 28b is configured to display images of registered subscribers, specifically, the image provided by the subscriber during the subscription process. The video monitor 28b may include an image matrix 38 that may accommodate one or more images 40a-40d of the registered subscribers on the network system 10. Preferably, the displayed images 40a-40d are of registered subscribers who are currently present in establishments other than the first establishment 16a in which the registered first subscriber 25a is currently present. Thus, subscribers present within the same establishment would not see images of each other displayed on the video monitor. For example, images 40a-40d of the registered subscribers in establishments other than the first establishment 16a are routed from the central server 12 through the computer network 14 to the server 26a of the first establishment 16a to then be displayed on the video monitor 28a. The image of the first subscriber 25a would appear in the image matrix of the video monitors 28b, 28c of the second and third establishment 16b, 16c, respectively. For example, assuming that the image 40a is the image associated with first subscriber 25a, the image matrix 38 of the video monitor 28b in the second establishment 16b would display the image 40a. Furthermore, an identifier, such as an identification number, corresponding to the subscriber shown is visually associated with each image 40a-40d. Thus, the identification number “123” that was assigned to first subscriber 25a may appear on, adjacent to, or in the vicinity of the image 40a of the first subscriber 25a within the image matrix 38. The images 40a-40d may cycle with other images of subscribers in other establishments at pre-determined intervals. Thus, the content of the image matrix 38 is dynamic in that images displayed may constantly vary throughout an evening. The images 40a-40d may be grouped by establishment and may be preceded by or have simultaneously displayed thereon an indicator designating which establishment the subscribers whose images are displayed are currently patronizing. Hence, the image 40a depicting the first subscriber 25a and the name of establishment 16a would be displayed on the video monitor 28b of establishment 16b for other subscribers, such as a second subscriber 25b, to view.

It is to be understood that the service provider 24 is able to control which profiles are displayed in each establishment based upon the demographical information of each establishment that is stored in the database 22. For example, if the first establishment 16a is frequented by mainly heterosexual patrons and the third establishment 16c is an openly gay establishment, then the central server 12 will not transmit images of individuals present in the first establishment 16a to the third establishment 16c. Rather, the central server 12 will transmit such images to establishments that are designated by the demographical information in the database 22 as being frequented by mainly heterosexual patrons. Similarly, demographical information, such as the typical socio-economic status of patrons frequenting a particular establishment, may be used to direct images to the appropriate establishments.

Upon viewing the images on the video monitor, a subscriber whose interest was piqued when viewing another subscriber's image may wish to initiate contact with that other subscriber. For example, the second subscriber 25b may be viewing the images 40a-40d displayed in the image matrix 38 of the video monitor 28b. Upon viewing the image 40a representative of the first subscriber 25a, the second subscriber 25b finds the first subscriber 25a to be attractive and thereby the second subscriber 25b wishes to initiate contact with the first subscriber 25a. It is to be understood that the network system 10 operating in the context of displaying heterosexual images will not allow a subscriber to contact another subscriber that is of the same sex. The second subscriber 25b then notes the identification number 36, i.e., “123”, of the first subscriber 25a. The second subscriber 25b may use his or her cellular phone 32c or any other suitable device to dial an access number provided by the service provider 24. When prompted, the second subscriber 25b may enter the identification number 36. The second subscriber 25b may then leave a voice-mail message for the first subscriber 25a. This message may range from a straightforward greeting to a detailed message providing contact information relating to the second subscriber 25b. The second subscriber 25b has the option to reveal as much or as little about him or herself. It is to be understood that the service provider 24 may limit the length of time allotted to leaving a message. Shortly thereafter, the network system 10 alerts the first subscriber 25a that a message has been left for them. This alert may be transmitted to the first subscriber 25a in any number of ways including, but not limited to, as an SMS text message to the cellular phone 32a of the first subscriber 25a, or as an instant message or e-mail message to a wireless device of the first subscriber 25a. It is envisioned that any such alert will include the identification number of the second subscriber 25b. Thus, upon receipt of the alert, the first subscriber 25a may view the images displayed on the video monitor 28a and be able to see which image corresponds to the identification number of the second subscriber 25b. Upon viewing the image of the second subscriber 25b, the first subscriber 25a may choose to ignore the second subscriber 25b or may listen to the voice-mail message left by the second subscriber 25b. Preferably, the voice-mail message is able to be listened to only once and is then deleted by the network system 10. Adhering to this protocol, allows the second subscriber 25b to leave a natural-sounding message, without worrying that the message would be replayed to embarrass him or her. The first subscriber 25a may then directly contact the second subscriber 25b according to the type of contact information that was provided in the voice-mail message. Thus, the first subscriber 25a may call the second subscriber 25b directly, send an SMS text message to the cellular phone 32c of the second subscriber 25b, or send an e-mail to the second subscriber 25b. Alternatively, if the first subscriber 25a is aware of the second establishment 16b in which the second subscriber 25b is present, the second subscriber 25b may wish to travel to the second establishment 16b to make contact with the second subscriber 25b in person. Optionally, it is also envisioned that the first subscriber 25a may dial the access number provided by the service provider 24, enter the identification number of the second subscriber 25b when prompted, and thereby be able to retrieve the profile of the second subscriber 25b to know more about second subscriber 25b before contacting him or her.

The kiosk 20d may be configured to allow the second subscriber 25b to input the identification number 36 of the first subscriber 25a through a console at the kiosk 20d. The kiosk 20d may then print out a photo corresponding to the picture 40a of the first subscriber 25a shown on the video monitor 28b. Additionally, the second subscriber 25b may also obtain and print out a background check relating to the first subscriber 25a. It is envisioned that the background check would maintain the anonymity of the first subscriber 25a, but would provide the second subscriber 25b with information relating to the criminal history (i.e., misdemeanors and higher) of the first subscriber 25a, if any. Instead of or in addition to printing out a hard copy, the kiosk 20d may be configured to send the photo or background information via email to the second subscriber 25b. Transaction fees for the photo or background information may be received by the service provider 24 in a variety of ways including, but not limited to, debiting the second subscriber 25b directly from a debit account or applying any costs incurred while utilizing the kiosk 20d to the monthly subscription fee charged to the second subscriber 25b. It is to be understood that the first subscriber 25a may also input the identification number of the second subscriber 25b into the kiosk at the first establishment 16a after the first subscriber views the picture of the second subscriber. The kiosk 20d may also be utilized by the second subscriber 25b to remotely purchase a beverage, meal, or flowers for the first subscriber 25a. For example, by utilizing a credit system, the second subscriber 25b may enter the identification number 36 of the first subscriber 25a and submit an alert to the first subscriber 25a informing them that they have now received a drink from the second subscriber 25b in the form of a drink credit. The account of the second subscriber 25b would be debited for the cost of a drink, whereas the account of the first subscriber 25a would be credited with the cost of the drink. In essence, the first subscriber 25a receives a drink at no cost to them.

In addition to providing a method for introducing individuals to each other, the network system 10 offers proprietary entertainment content delivered directly to the establishment and displayed on the video monitor 28b. Similar to the images, the entertainment content may be routed from the central server 12 through the computer network 14 to servers 26a-26c of the respective establishment. The entertainment content may encompass a variety of subject matter including, but not limited to, a trivia game, a live camera view depicting other establishments, a sports game, a sports highlight, and a sports interview. Specifically, the entertainment content may be displayed in one or more frames of the video monitor 28b. For example, a trivia frame 42 may display random trivia questions, which would allow individuals within the establishment to compete against each other. It is to be understood that the entertainment content may include an interactive element, thereby allowing for competition with oneself as a subscriber or between other subscribers. For example, the second subscriber 25b may utilize his or her cellular phone 32c to answer the trivia questions displayed in the trivia frame 42. A scoring system may be maintained by the service provider to allow the central server 12 to maintain a record of correct guesses by each subscriber. A reward system may be employed by the service provider 24 under which the subscriber is rewarded for accumulating a certain percentage of correctness. Such rewards may include, but are not limited to, promotional gifts or free beverages. As a further example of entertainment content displayed on the video monitor 28b, a live cam frame 44 may display a live video feed via camera 30a, showing the inside of the first establishment 16a. The live cam frame 44 may also display the name of the first establishment 16a, e.g., Joe's Bar. The live video feed may be useful to patrons of the second establishment 16b in establishing as to whether or not they would be interested in visiting the first establishment 16a or remaining in the second establishment 16b. As shown in FIG. 2, the entertainment content and the image matrix 38 are displayed in separate frames, yet it is to be understood that the entertainment content may occupy the entire viewable area of the video monitor 28b. It is to be understood that the aforementioned entertainment content is mentioned for exemplary purposes and should not be construed as limiting the types of subject matter that may be classified as entertainment content to be displayed on the video monitor 28b.

In addition to entertainment content, advertising content may also be transmitted by the service provider 24 and be displayed on the video monitor 28b. Specifically, the entertainment content may be displayed in one or more frames, such as advertising frame 46a and advertising frame 46b. The advertising content may encompass a variety of subject matter including, but not limited to, drink specials, concert promotions, merchandise, and vacations. It is to be understood that the network system 10 is not subject to governmental imposed broadcasting restrictions. Therefore, in addition to mainstream advertising, the video monitor 28b may also display advertisements that may be considered inappropriate for traditional broadcasting mediums. For example, the first advertising frame 46a may display an advertisement for cigarettes. In another example, the second advertising frame 46b may contain information concerning a Bahamas vacation, the advertised price thereof, and the contact information necessary to obtain more information and/or purchase the vacation. Any of the advertising displayed within the advertising frames 46a, 46b may be qualified by attaching a “shelf life” to them. For example, if the advertising frame 46a contains a bar special for a particular drink, the advertisement may be qualified by indicating within the advertisement that the bar special expires within a set period of time, e.g., fifteen minutes. It is to be understood that due to the demographical information available to the service provider 24, targeted advertising and marketing based upon the demographics of the clientele frequenting the establishment as well as the demographics of the establishment itself may be delivered to each particular affiliate establishment. For example, a 30 to 50 year old crowd may be exposed to an advertisement for a luxury automobile, whereas a 21 to 29 year old crowd may be exposed to a beer commercial.

Furthermore, the video monitor 28b may include a promotion frame 48 that may display content that promotes the network system 10 itself, thereby providing non-subscribers with information as to how they may become subscribers of the network system.

Preferably, the video monitors do not output sound due to the inherent noise levels associated with social establishments. The content displayed on the video monitors is therefore designed to be effectively communicated through images, animation, and video. Any audio that is associated with content on the video monitor may either be conveyed in the form of text subtitles or may be accessible to the second subscriber 25b through an audio communications device, such as the cellular phone 32c. For example, there may be an audio identifier 50 associated with particular content displayed on the video monitor that indicates that an audio stream accompanies that particular content. This audio stream would only be made available to subscribers of the network system 10. Thus, similar to how the second subscriber 25b utilizes another subscriber's identification number to initiate contact with him or her, the second subscriber 25b may use the audio identifier 50 to access the audio portion of the content displayed on the video monitor. For example, the second subscriber 25b may observe the Bahamas vacation depicted in the second advertising frame 46b. The second advertising frame 46b also makes reference to a password which, when provided to the operator after dialing the contact number, i.e., “1-800-BAHAMAS”, would entitle the second subscriber 25b to the discounted advertised price, i.e., “$399”. The second subscriber 25b would dial the access number provided by the service provider 42, and when prompted would enter the audio identifier 50 associated with the Bahamas vacation namely, “#8”. Thereafter, the second subscriber 25b would be provided with the password necessary to obtain the Bahamas vacation at the discounted advertised price. It is to be understood that any content presented on the video monitor 28b may have audio content associated with it. As a further example, a sports interview may be shown on the video monitor without subtitles. The only way to listen to the simultaneously broadcast audio portion of the sports interview is to enter the corresponding audio identifier. The audio content of any such broadcast may also be made available to subscribers on the web site operated by the service provider 24. This feature is useful in that it allows a subscriber who may have missed a portion of the broadcast or the broadcast as a whole the opportunity to listen to the broadcast at a future time. It is to be understood that only subscribers are able to take advantage of the incentives or audio broadcasts relating to the visual content displayed on the video monitor 28b, as accessing the audio is limited to subscribers to the network system 10. Consequently, this arrangement provides yet another incentive for non-subscribers to subscribe to the network system 10. Furthermore, different subscription levels may be employed to provide higher value features or services to higher subscription level subscribers.

A further aspect to the invention involves a subscriber to the network system 10 having access to a web site managed by the service provider 24. The web site operates in conjunction with the central server 12 to allow a subscriber who is not present within an affiliate establishment (e.g., accessing the web site from home on their desktop computer 20a) to log in to the web site and view the images of subscribers who are currently present at any of the affiliate establishments. Although the subscriber is able to view the images, he or she is not able to contact any of the pictured subscribers. Thus, an incentive is created for the subscriber to travel to and enter any of the affiliate establishments since only then, upon registering with the system, is he or she able to contact any of the other subscribers. The web site may also serve a function of providing information relating to special events that may be occurring at each affiliate establishment, either at the present or in near future. Furthermore, the web site may offer coupons valid for drink and/or meal specials that the subscriber may print out and bring to the appropriate affiliate establishment. Due to the highly networked environment of the network system 10, the content associated with each establishment on the service provider web site may be quickly and easily altered by the proprietor of each affiliate establishment. For example, the coupons may have a “shelf life”, e.g., valid only for that particular evening and, therefore, the promotion advertised thereon may change from day to day or from hour to hour as determined by the proprietor of each affiliate establishment.

It is envisioned that revenue from operation of the network system 10 would be derived from any one or all of the following: individual subscription fees, affiliate establishment subscription fees, and advertising fees. It is to be understood that the presentation of images, entertainment, and advertising/promotion is based upon the notion of revolving content controlled by the service provider 24 and provided to each affiliate establishment. Thus, even the frame layout is dynamic and does not necessarily need to be configured as shown in FIG. 2. Each affiliate establishment may include wholly different content and layout thereof. By providing revolving dynamic content, the video monitor displays an overall visual dynamic content. This is deemed to be an important aspect of the present invention, as it lends itself to focusing the attention of subscriber individuals and non-subscriber individuals to the video monitor, and thereby resulting in increased revenue.

It is envisioned that each establishment utilizing the network system 10 is in a different geographic location within a city, so as to provide each establishment with a competitive advantage over establishments that are not utilizing the network system 10. For example, the first establishment 16a would be sufficiently geographically distanced from the second establishment 16b, preferably not within reasonable walking distance of the first establishment 16a. Although it is envisioned that the network system 10 displays profiles and registers subscribers within a single city, it is to be understood that the network system 10 may be implemented to show profiles of subscribers from more than one city. Accordingly, additionally information may be displayed in the image matrix 38, such as the city name and/or region.

The above invention has been described with reference to the preferred and alternative embodiments. Obvious modifications, combinations, and alterations will occur to others upon reading the preceding detailed description. It is intended that the invention be construed as including all such modifications, combinations, and alterations insofar as they come within the scope of the appended claims or the equivalents thereof.

1. A network system for effecting social introductions between individuals, comprising:
a first subscriber subscribed to the network system;
a second subscriber subscribed to the network system;
a service provider server configured to transmit content, wherein the content is at least one of a first image and a second image, wherein the first image is representative of the first subscriber and the second image is representative of the second subscriber;
a first establishment, wherein the first establishment is comprised of:
a first establishment server configured to receive the second image from the service provider server;
a first video monitor configured to display the second image; and
a second establishment, wherein the second establishment is comprised of:
a second establishment server configured to receive the first image from the service provider server;
a second video monitor configured to display the first image; and
a computer network configured to route the first image to the second establishment and the second image to the first establishment, wherein the first image is displayed on the second video monitor as a function of a first registration by the first subscriber with the network system and the second image is displayed on the first video monitor as a function of a second registration by the second subscriber with the network system.

2. The network system of claim 1, wherein the first registration is one of automatic registration and manual registration, and the second registration is one of automatic registration and manual registration.

3. The network system of claim 2, wherein the automatic registration alerts the network system of the presence of the first subscriber in the first establishment by utilizing a wireless device, wherein the first establishment is a hot-zone.

4. The network system of claim 2, wherein the manual registration alerts the network system of the presence of the first subscriber in the first establishment by one of:
a) scanning a member card;
b) utilizing a personal communication device; and
c) utilizing biometric recognition.

5. The network system of claim 1, wherein an identifier corresponds to and is displayed in association with the first image.

6. The network system of claim 2, wherein:
the second subscriber views the first image;
the second subscriber enters the identifier into a first communications device;
the second subscriber leaves a message intended for the first subscriber utilizing the first communications device;
the message is received and stored by the service provider server;
the service provider server transmits an alert to a second communications device; and
the first subscriber views the alert utilizing the second communications device.

7. The network system of claim 6, wherein the first subscriber retrieves the message from the service provider server utilizing the second communications device.

8. The network system of claim 6, wherein the first subscriber retrieves a profile representative of the second subscriber.

9. The network system of claim 7, wherein the first subscriber contacts the second subscriber.

10. The network system of claim 1, further comprising a mobile telecommunications network communicatively connected to the subscriber network system.

11. The network system of claim 1, wherein the service provider server is configured to store a plurality of profiles in a database.

12. The network system of claim 1, wherein the second video monitor is configured to display at least one of advertising content and entertainment content.

13. The network system of claim 12, wherein at least one of the advertising content and entertainment content includes a corresponding audio portion.

14. The network system of claim 13, wherein the corresponding audio portion is transmitted to the first communications device.

15. The network system of claim 1, further comprising a camera installed in at least one of the first establishment and the second establishment.

16. The network system of claim 1, further comprising a kiosk utilized to subscribe to the network system.

17. A method for effecting social introductions between individuals, using a network system, comprising the steps of:
subscribing a first subscriber and a second subscriber with the network system;
transmitting an image of the first subscriber to a second establishment as a function of the first subscriber registering with the network system;
transmitting an image of the second subscriber to a first establishment as a function of the second subscriber registering with the network system;
displaying the first subscriber image on a second video monitor, the second video monitor situated within the second establishment;
displaying the second subscriber image on a first video monitor, the first video monitor situated within the first establishment;
corresponding a first identifier with the first subscriber image and displaying the first identifier in association with the first subscriber image.
corresponding a second identifier with the second subscriber image and displaying the second identifier in association with the second subscriber image;
entering the first identifier into the network system by use of a first communications device;
storing a message from the second subscriber for the first subscriber; and
transmitting an alert to the first subscriber, wherein the alert includes the second identifier.

18. The method of claim 17, including the additional step of the first subscriber contacting the second subscriber.

19. The method of claim 17, wherein after receiving the alert, the first subscriber retrieves a profile representative of the second subscriber.

20. The method of claim 17, further comprising the steps of:
transmitting at least one of advertising content and entertainment content to the first establishment; and
displaying the at least one of the advertising content and the entertainment content on the first video monitor.
